(19) United States
(12) Patent Application Publication
(10) Pub. No.: US 2013/0262176 A1
(43) Pub. Date: Oct. 3, 2013

(54) HYBRID BALANCING OF SUPPLY AND DEMAND

(71) Applicant: KINAXIS INC., Ottawa (CA)

(72) Inventors: Yankai ZHANG, Ottawa (CA); Robert Douglas MACMILLAN, Stittsville (CA); Paul Frederick HAVILAND, Smith Falls (CA); Andrey KORNIENKO, Ottawa (CA); Jules Robert D'ENTREMONT, Kanata (CA)

(73) Assignee: KINAXIS INC., Ottawa (CA)

(21) Appl. No.: 13/835,912

(22) Filed: Mar. 15, 2013

Related U.S. Application Data
(60) Provisional application No. 61/617,953, filed on Mar. 30, 2012.

(51) Int. Cl. G06Q 10/06

(52) U.S. Cl. CPC G06Q 10/06315
USPC 705/7.25

(57) ABSTRACT

Certain embodiments include methods, systems, and non-transitory computer program products for fulfilling supply and demand. The method includes receiving a demand for a resource, and determining a plurality of relationships among related resources. The related resources can represent dependent resources needing to be fulfilled in order to fulfill the demand for the resource. The relationships can group the related resources into levels according to the dependencies. For each level, the method further includes processing dependent resources depth-first proceeding down levels, if an importance of the related resources indicates there are no more important related resources to process at the level, and interrupting the depth-first processing to process related resources breadth-first at the level, if the importance of the related resources indicates there are more important related resources at the level.

### CROSS-REFERENCE TO RELATED APPLICATIONS

This application claims benefit under 35 U.S.C. §119(e) of U.S. Provisional Patent Application No. 61/617,953, entitled “Hybrid Balancing of Supply and Demand,” filed Mar. 30, 2012, which is expressly incorporated by reference herein in its entirety.

### FIELD OF THE DISCLOSURE

The present disclosure relates generally to systems and methods for order supply and demand fulfillment, and specifically to systems and methods for hybrid balancing of supply and demand.

### BACKGROUND

Supply and demand refers to fulfilling orders (i.e., demands) for parts or resources according to available supply of corresponding subparts or components needed for the resources. Traditional supply and demand algorithms often fulfill orders for resources breadth-first (only), or depth-first (only).

### Breadth-First Algorithms

Many breadth-first planning algorithms exist for fulfilling orders according to supply and demand. Such algorithms proceed level-by-level. Manufacturing resource planning (MRP) represents a traditional breadth-first algorithm. A strength of breadth-first algorithms is that they collect all demands for a part before satisfying any demands. That way, breadth-first systems have a complete picture of demands and their priorities across the entire planning horizon and can therefore make good decisions about which demands to satisfy first. A weakness of breadth-first algorithms is as follows: when supply does not exist at the current level, the breadth-first system must decide how to get supply from the next level. If only one choice exists, then everything is fine. But if multiple choices exist—either due to multiple suppliers for a part or due to substitute parts that can be used instead—then breadth-first systems make a choice about which path to use based on rules, and not based on availability at lower levels. For example, an algorithm might choose one supplier over another because the first supplier is farther away from its target monthly shipment than the second one. It might turn out, however, that the first supplier cannot provide supply on time, due to constraints at lower levels, while the second supplier can provide supply on time.

### Depth-First Algorithms

Depth-first algorithms also exist, also known as order-by-order algorithms. Strengths and weaknesses of depth-first algorithms are the reverse of breadth-first algorithms. For a single order, a depth-first algorithm proceeds down levels, evaluating whether supply is available on time. If one path cannot provide supply on time, the depth-first system can evaluate other paths and choose the one that provides on-time or least-late supply. The problem is that, at each level, depth-first algorithms lack the full demand picture. One order might use supply at a particular level because that supply is still available. But a subsequent order might create demand for the same part, and this demand might be earlier or more important than the demand already processed. The undesired result might be that the second order is unnecessarily late.

### SUMMARY

In accordance with the disclosed subject matter, methods, systems, and non-transitory computer program products are provided for fulfilling supply and demand.

Certain embodiments include methods for fulfilling supply and demand. The method includes receiving a demand for a resource, and determining a plurality of relationships among related resources. The related resources can represent dependent resources needing to be fulfilled in order to fulfill the demand for the resource. The relationships can group the related resources into levels according to the dependencies. For each level, the method further includes processing dependent resources depth-first proceeding down levels, if an importance of the related resources indicates there are no more important related resources to process at the level, and interrupting the depth-first processing to process related resources breadth-first at the level, if the importance of the related resources indicates there are more important related resources at the level.

Certain embodiments include systems for fulfilling supply and demand. The system can include memory, storage, and at least one processor. The processor can be configured to use the memory and storage to receive a demand for a resource and determine relationships among related resources. The related resources can represent dependent resources needing to be fulfilled in order to fulfill the demand for the resource. The relationships can group the related resources into levels according to the dependencies. For each level, the processor can be configured to process dependent resources depth-first proceeding down levels, if an importance of the related resources indicates there are no more important related resources to process at the level, and interrupt the depth-first processing to process related resources breadth-first at the level, if the importance of the related resources indicates there are more important related resources at the level.

Certain embodiments include non-transitory computer program products for fulfilling supply and demand. The non-transitory computer program product can be tangibly embodied in a computer-readable medium. The non-transitory computer program product can include instructions operable to cause a data processing apparatus to receive a demand for a resource. The non-transitory computer program product can determine a plurality of relationships among related resources. The related resources can represent dependent resources needing to be fulfilled in order to fulfill the demand for the resource. The relationships can group the related resources into levels according to the dependencies. For each level, the instructions can be operable to cause the data processing apparatus to process dependent resources depth-first proceeding down levels, if an importance of the related resources indicates there are no more important related resources to process at the level, and interrupt the depth-first processing to process related resources breadth-first at the level, if the importance of the related resources indicates there are more important related resources at the level.

The embodiments described herein can include additional aspects of the present invention. For example, the resources can represent at least one of elements for allocation, objects for allocation, individuals for allocation, parts for order fulfillment, and components for order fulfillment. The method, system, and non-transitory computer program product can include, for each level, managing a resource pool by first processing the related resources without attributes needing dynamic simulation, prior to processing the related resources with attributes needing dynamic simulation. The processing the dependent resources depth-first can include processing the dependent resources in a sequence, based at least in part on at least one of a projected availability date, a due date, an importance, a priority, and a required quantity for each resource. The dynamic simulation can include modifying at least one of a projected availability date, a due date, an importance, a priority, and a required quantity for the related resource, based at least in part on at least one of the projected availability date, the due date, the importance, the priority, and the required quantity of the dependent resources. In further aspects, the dynamic simulation can include determining an availability of a potential path, reserving dependent resources for the potential path, and releasing the dependent resources if an alternate path is found which better meets the demand for the resource. In still further aspects, the processing the dependent resources and the processing the related resources can include determining whether at least one of the availability date, the due date, the importance and the priority can be satisfied at the level, based at least in part on the required quantity.

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates a non-limiting example of a system for hybrid balancing of supply and demand in accordance with certain embodiments of the present disclosure.

FIG. 2 illustrates an example of a method that the system performs for hybrid balancing of supply and demand in accordance with certain embodiments of the present disclosure.

FIG. 3 illustrates an example of the method that the system performs for processing a level in accordance with certain embodiments of the present disclosure.

FIG. 4 illustrates an example of the method that the system performs for processing an event depth first in accordance with certain embodiments of the present disclosure.

FIG. 5 illustrates an example of the method that the system performs for performing a trial on a path in accordance with certain embodiments of the present disclosure.

FIG. 6 illustrates a non-limiting example of a system for event pool management in accordance with certain embodiments of the present disclosure.

FIG. 7 illustrates an example application of the method that the system performs for hybrid balancing of supply and demand in accordance with certain embodiments of the present disclosure.

### DETAILED DESCRIPTION

In general, the present disclosure includes systems, methods, and non-transitory computer program products for hybrid balancing of supply and demand. The present systems and methods can include receiving a demand for a resource. An example of a demand can be a customer order. The present systems and methods can include determining relationships among related resources. For example, the related resources can represent dependent resources needing to be fulfilled in order to fulfill the demand for the resource. The relationships can group the related resources into levels according to the dependencies. For each level, the present systems and methods can include processing dependent resources depth-first proceeding down levels, if an importance of the related resources indicates there are no more important related resources to process at the level. The present systems and methods can also include interrupting the depth-first processing to process related resources breadth-first at the level, if the importance of the related resources indicates there are more important related resources at the level.

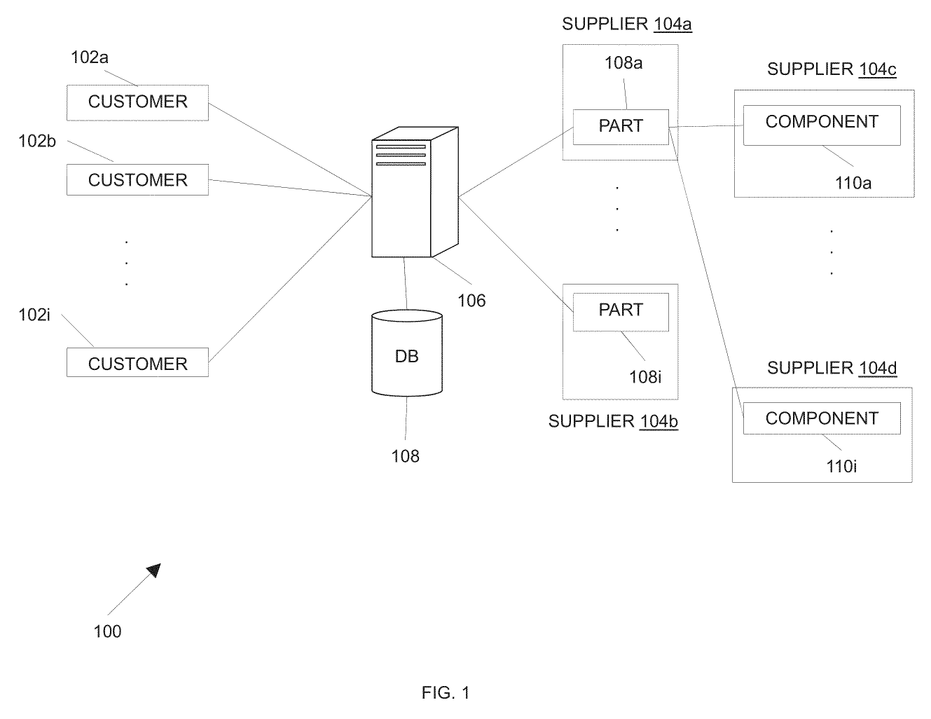

Turning to the figures, FIG. 1 illustrates a non-limiting example of a system 100 for hybrid balancing of supply and demand in accordance with certain embodiments of the present disclosure. System 100 includes customers 102a-i, a server 106 and a database 108, and suppliers 104a-d. Customers 102a-i place orders for parts 108a-i. These orders represent demand in supply-and-demand fulfillment. Suppliers 104a-d fulfill orders according to supply and demand. Supply and demand refers to fulfilling orders (demand) based on available supply. Orders can include parts 108a-i. Parts 108a-i can be available from suppliers such as suppliers 104a, b. In some embodiments, the same supplier could also supply multiple parts and/or components, such as supplying parts and corresponding components. More generally, the present system works for allocating elements, resources, or other entities according to demand. For example, the present system can allocate engineers or other individuals to complete business projects, or allocate machines to tasks. Accordingly, the present systems and methods can be used for hybrid balancing of any supply-and-demand-based problem. Demand can be generated from customers 102a-i by placing orders, or demand can be propagated from other orders or components in the supply chain.

Parts 108a-i can include subparts or components 110a-i. Components 110a-i can also be available from suppliers such as suppliers 104c, d. The parts and components described herein can be provided from multiple suppliers or a single supplier, in varying combinations. Parts or components may arrive late, or in short supply. Parts or components may have hierarchical requirements. For example, part A may require components B1 and B2. Components B1 and B2 may themselves require components C1 and C2. Furthermore, parts or components may be shared. For example, part A1 may use component B, and part A2 may also use component B. Lastly, system 100 may also take into consideration constraints such as capacity considerations. Accordingly, system 100 performs hybrid balancing of supply and demand to prioritize orders at various levels for efficient fulfillment.

Of course, system 100 may also include additional features and/or functionality. For example, system 100 may also include additional storage (removable and/or non-removable) including, but not limited to, magnetic or optical disks or tape. Storage media includes volatile and nonvolatile, removable and non-removable media implemented in any method or technology for storage of information such as computer-readable instructions, data structures, program modules or other data. Non-transitory computer-readable storage media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media may be part of system 100.

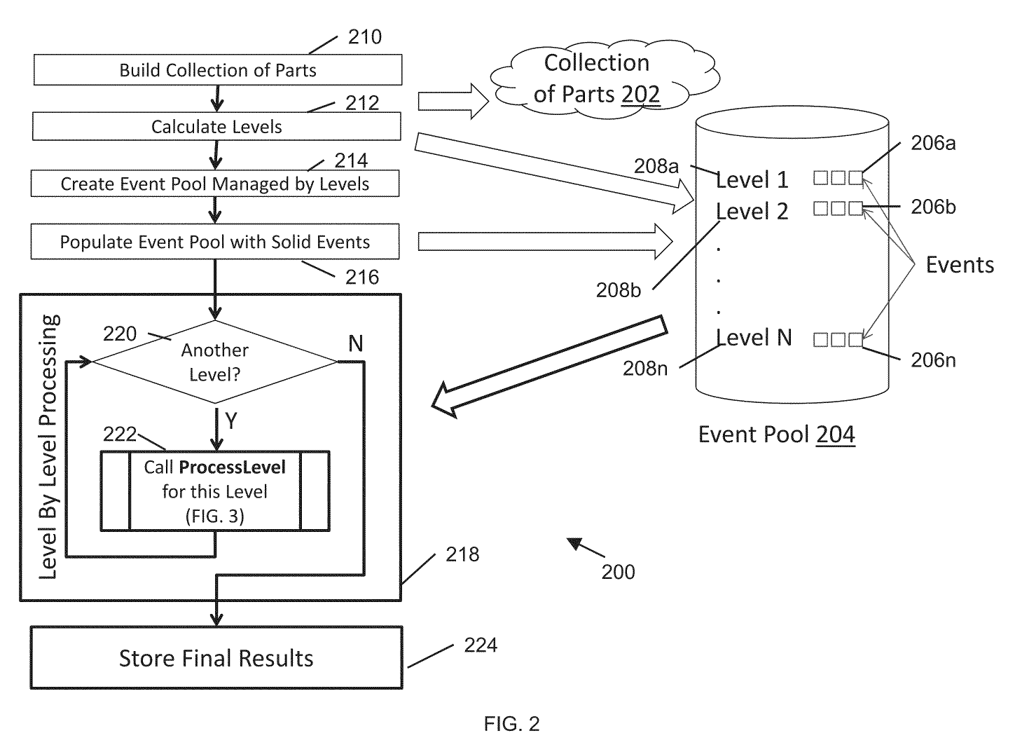

FIG. 2 illustrates an example of a method 200 that the system performs for hybrid balancing of supply and demand in accordance with certain embodiments of the present disclosure. Method 200 uses a collection 202 of parts and/or components, and an event pool 204. Event pool 204 includes events 206a-n and levels 208a-n. Events represent demand for parts or components. Events can represent independent or dependent requirements. Levels 208a-n correspond to levels of fulfillment required to fulfill an order. More generally, levels 208a-n represent relationships between events 206a-n and/or relationships between parts or components. For example, events can be managed according to a part low level code. In some embodiments, a low level code determines a level of fulfillment. For example, a part or component with a level code indicating level 1 represents a part with no parent part above it. A component with a level code indicating level 2 represents a part with one parent part above it. The parent part requires the component before the event or demand can be fulfilled.

The present system performs hybrid balancing of supply and demand as follows. The system builds a collection 202 of parts and/or components (step 210). The present system calculates levels for each part or component in collection 202 (step 212). For example, the present system can analyze structural relationships between parts and components, determine component requirements, and assign levels accordingly. As described earlier, parts or components with no parent parts or component parts can be assigned level 1, and subsequent parts or components can be assigned levels incrementing by one for each level of dependency (e.g., level 2, 3, 4, etc.). Of course, other indexing schemes can be used for the levels or groups. For example, the levels can be zero-indexed, beginning with level 0 rather than level 1. The present system creates an event pool (step 214). For example, the present system can create event pool 204 based on the calculated levels. As described earlier, event pool 204 is managed by levels.

The present system populates the event pool with solid events (step 216). As used herein, “solid events” refer to independent requirements for parts within collection 202 of parts, and also dependent requirements from outside collection 202 of parts. For example, independent requirements can refer to multiple orders from customers or customer forecasts. Dependent requirements can refer to subparts or components required to make a parent part. One aspect of solid events is that, because they arise from either independent requirements for parts within the collection of parts or from dependent requirements from outside the collection of parts, the solid events have attributes (such as due date, or priority) that can be determined with certainty, and cannot be altered dynamically based on demands or requirements within the current calculation. For example, the present system can populate the event pool as follows. Based on customer orders and forecasts, those corresponding events are known to have no dependencies on other parts, so they can be categorized as solid events. The present system then analyzes dependent requirements from parent parts. If a parent part is not in collection 202 of parts, the present system is able to determine those dependent requirements with certainty and the event or demand corresponding to the parent part can be categorized as a solid event. If a parent part is within collection 202 of parts, the present system cannot yet determine dependent requirements with certainty, therefore events corresponding to the parent part can be categorized as dependent dynamic events.

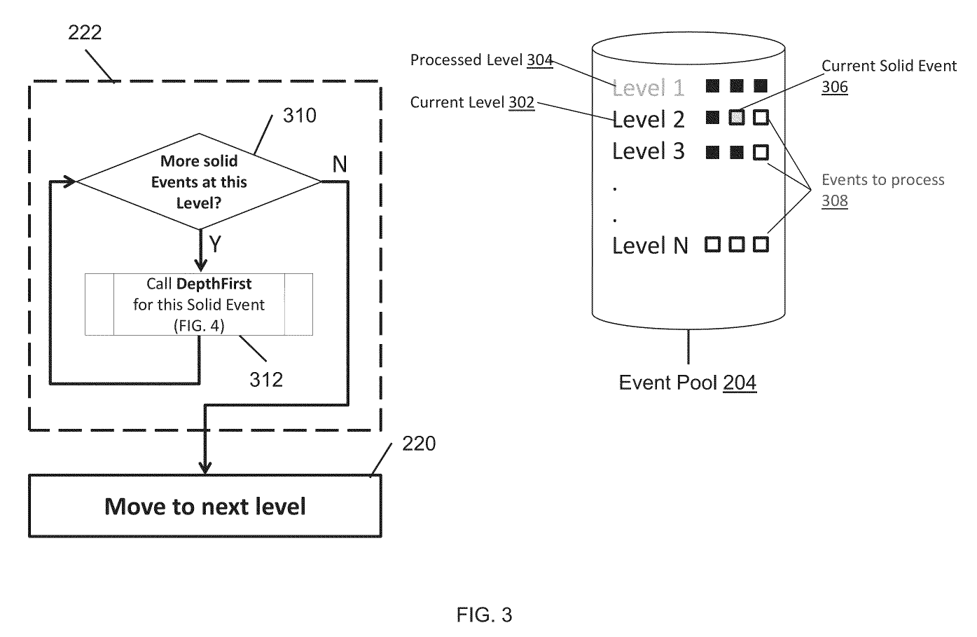

The present system then proceeds level by level, as illustrated in box 218. The present system determines whether there is another level (step 220). If there is another level (step 220: Yes), the present system processes the current level (step 222). Processing the current level is shown in further detail in connection with FIG. 3. After the present system finishes processing the current level, processing returns to determine whether there is another level (step 220).

If there is no other level (step 220: No), the present system stores final results for each part or component (step 224). Storing final results refers to caching or reporting the determined results for each part or component in collection 202 of parts.

FIG. 3 illustrates an example of the method 222 that the system performs for processing a level in accordance with certain embodiments of the present disclosure. Method 222 uses event pool 204. Method 222 tracks a current level 302 and a processed level 304. Current level 302 can include a current solid event 306 (shown in gray). Events 308 to process (shown in white) represent the events (i.e., demands) waiting in event pool 204 to be processed. As described earlier, the processing proceeds level by level to manage events per level, and sorts the events by importance of the demand. Measures of importance are described in further detail following. Processed events (shown in black) represent events that have already been processed depth first (shown in step 312).

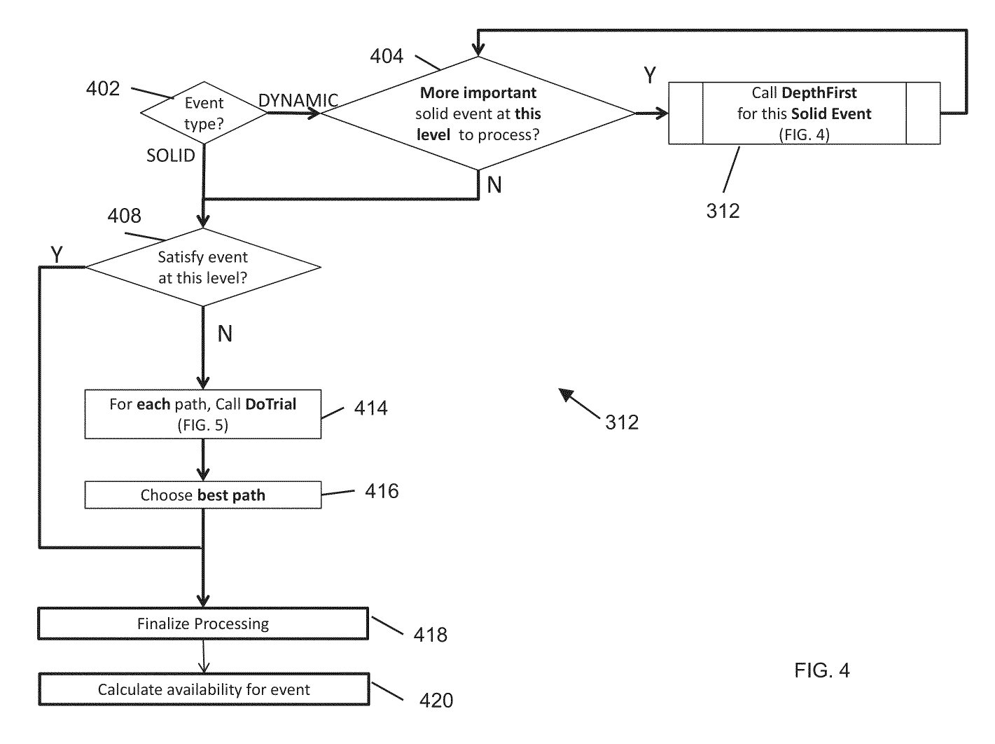

Method 222 determines whether there are more solid events to process at the current level (step 310). For example, method 222 can operate on current solid event 306 at current level 302. If there are more solid events to process at the current level (step 310: Yes), method 222 selects the next solid event and processes the solid event depth first (step 312). Step 312 is described in further detail later, in connection with FIG. 4. If there are no more solid events at the current level (step 310: No), method 222 completes and moves to the next level (if there is another level) (step 220). For example, as part of completing, the present system can cache or report the determined results for each part or component in the level.

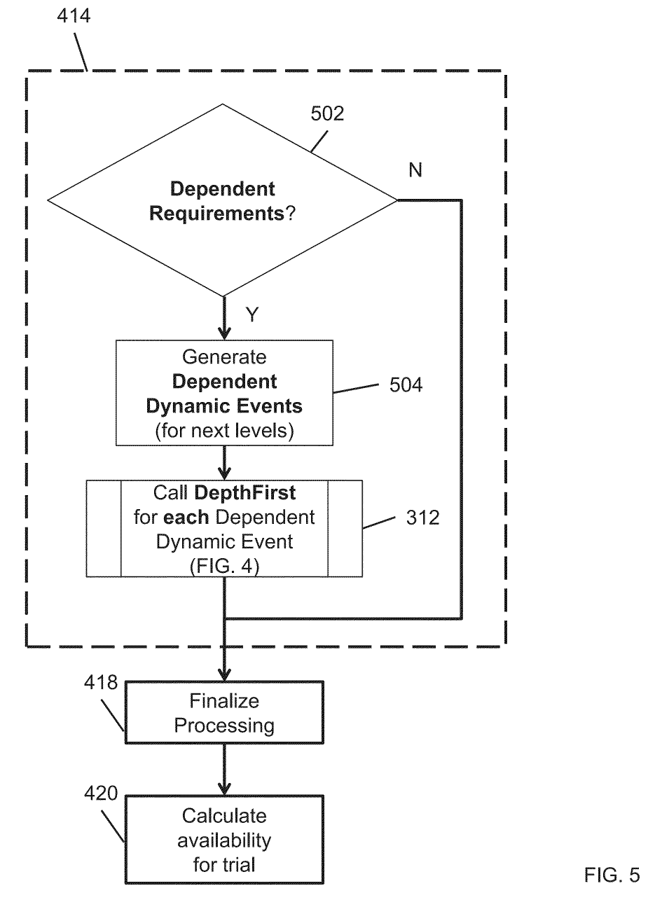

FIG. 4 illustrates an example of the method 312 that the system performs for processing an event depth first in accordance with certain embodiments of the present disclosure. Events processed by method 312 can be either solid events or dependent dynamic events. Solid events are processed when method 312 is invoked from FIG. 3 or from FIG. 4. As described earlier, a solid event refers to events (i.e., demands) with attributes (such as due date, or priority) that can be determined with certainty, and cannot be altered dynamically based on demands or requirements within the current calculation. Dependent dynamic events are processed when method 312 is invoked from FIG. 5. A dependent dynamic event refers to component or part requirements associated with a trial. A trial refers to a hypothetical or dynamic simulation of fulfilling an event (i.e., demand). Trials can be committed or cancelled. A trial can be cancelled if its corresponding path is not selected, i.e. if there are multiple paths and a better path is selected. Accordingly, dependent dynamic events are referred to as dynamic because their attributes can change, for example if a trial is cancelled. Dependent dynamic events are described in further detail later, in connection with FIG. 5.

Method 312 determines the event type (step 402). As described earlier, an event may be a solid event or a dependent dynamic event. If the event is a dependent dynamic event (step 402: Dynamic), the present system determines whether there is a more important solid event at the current level to process (step 404). Method 312 proceeds down this path if method 312 was invoked from FIG. 5. Because method 312 evaluates events at the current level, method 312 proceeds in a breadth-first manner in accordance with hybrid balancing. In some embodiments, the present system determines whether there is a more important solid event by comparing attributes about the event. Non-limiting example comparisons can include selecting an event with an attribute of an earlier or more urgent due date, or selecting an event with an attribute of a higher priority. Additional examples of attributes can include a number of supply choices for a given event or demand, or expiration requirements for an event or demand.

If there is a more important solid event at the current level to process (step 404: Yes), the present system recursively processes the more important solid event depth first (step 312). Method 312 proceeds down this path if method 312 is invoked from FIG. 3 or FIG. 4. Accordingly, method 312 for processing an event depth first is a recursive method, repeating depth first processing of an event until it reaches a point where there are no more levels to process, that is, a base case. After depth-first processing of a solid event completes (step 312), the present system proceeds to determine whether there is another more important solid event at the current level (step 404). The recursion terminates when no more important solid events at the current level remain to be processed (step 404: No).

If there is no more important solid event at the current level to process (step 404: No), the system proceeds to determine whether the current event can be satisfied at the current level (step 408). As used herein, satisfying an event at the current level refers to determining whether there are sufficient supplies at the current level. For example, an event or demand can be satisfied by: (1) using an available supply of parts or components, (2) rescheduling an in-process supply, or (3) recommending new supply to satisfy the event or demand. Furthermore, an event can be satisfied at differing grades of satisfaction. For example, an event or demand can be satisfied fully or partially, on time or late.

If the current event or demand can be satisfied at the current level (step 408: Yes), method 312 proceeds to finalize processing (step 418). As used herein, finalizing processing refers to committing the best chosen path (or the only path if there is no other choice), logging dependent dynamic demand as processed demand, consuming the supply that satisfies those demands, and releasing previously reserved supplies on other un-chosen paths. Method 312 calculates availability for the current event or demand (step 420). Calculating availability for the current event or demand refers to determining attributes such as available date and available quantity for a demand, based on attributes such as the satisfied supply availability date and available quantity.

If the current event cannot be satisfied at the current level (step 408: No), the present system performs a trial on the path (step 414), for each path if there are multiple paths to the next level. Multiple paths to the next level represent the existence of multiple suppliers who can supply a part or component, or available substitutes for a part or component. Performing a trial on the path is described in detail later in connection with FIG. 5. When the trials are complete for each path, method 312 selects the best path (step 416). In some embodiments, if there is only a single path to the next level, the present system chooses the single path as the best path. If there are multiple paths to the next level, in some embodiments, the best path is determined by whether supply for the path is on time. If no paths can provide supply on time, the best path can be determined by selecting the path which will be the least late. If multiple paths will arrive on time, the present system can allow administrators to configure planning rules. For example, an administrator can configure a ratio-based split between the multiple paths, or the present system can select a single path. Method 312 finalizes processing (step 418) and calculates availability for the current event (step 420), as described earlier.

FIG. 5 illustrates an example of the method 414 that the system performs for performing a trial on a path in accordance with certain embodiments of the present disclosure. Method 414 determines whether there are dependent requirements (step 502). As used herein, dependent requirements refer to subparts or components required to make a parent part. If there are no dependent requirements (step 502: No), the present system proceeds to finalize processing (step 418) and calculate availability for trial (step 420). As described earlier, finalizing processing refers to committing the best chosen path (or the only path if there is no other choice), logging dependent dynamic demand as processed demand, consuming the supply that satisfies those demands, and releasing previously reserved supplies on other un-chosen paths. As described earlier, calculating availability for the current event or demand refers to determining attributes such as available date and available quantity for a demand, based on attributes such as the satisfied supply availability date and available quantity.

If there are dependent requirements (step 502: Yes), the present system generates dependent dynamic events for the next levels (step 504). As described earlier, dependent dynamic events refer to events whose attributes and component or part requirements can change based on the results of trials. For each dependent dynamic event generated, the present system processes the dependent dynamic event depth first (step 312). As described earlier, the present system proceeds to finalize processing (step 418) and calculate availability for trial (step 420).

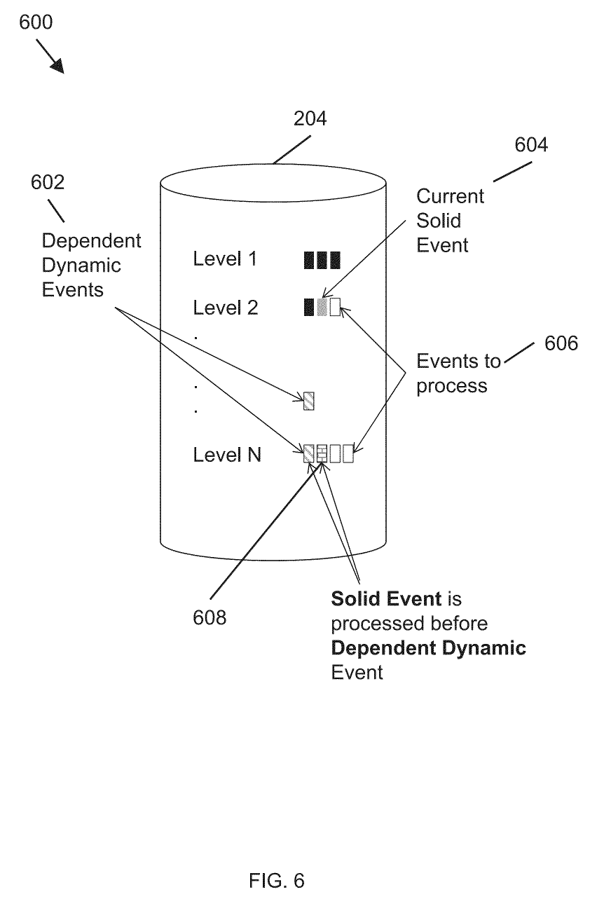

FIG. 6 illustrates a non-limiting example of a system 600 for event pool management in accordance with certain embodiments of the present disclosure. Event pool 204 includes dependent dynamic events 602, a current solid event 604, and events 606 to process. As shown via event 608, solid events are processed before dependent dynamic events.

### EXAMPLE

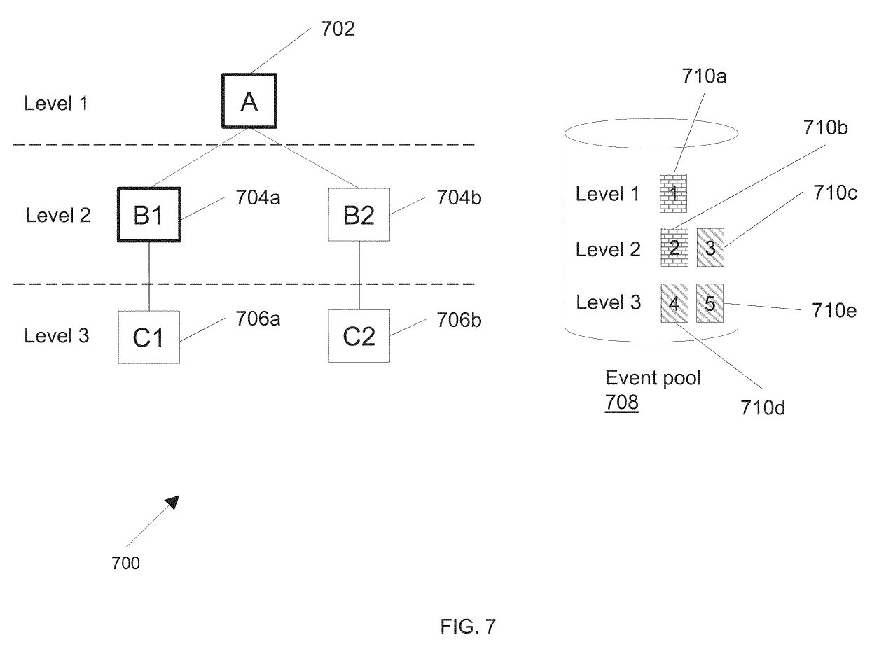

FIG. 7 illustrates an example application of the method that the system performs for hybrid balancing of supply and demand in accordance with certain embodiments of the present disclosure. FIG. 7 includes part A 702, parts B1 704a and B2 704b, components C1 706a and C2 704b, and an event pool 708. Assume the present system receives a demand or order for part A 702 from an ordering site 0. The demand for part A 702 can be satisfied by supply either from part B1 704a or from part B2 704b. Part B1 704a can be procured from assembly site 1. Part C1 706a is a component of part B1 704a at assembly site 1. Part B2 704b can be procured from assembly site 2. Part C2 706a is a component of part B2 704b at assembly site 2.

Part A 702 can have a customer order with due date=February 1, priority=medium, and quantity=100. Part B1 704a can also have a customer order with due date=February 10, priority=high, and quantity=100. Component parts C1 706a and C2 706b can have inventory (i.e., available supply)=100, but the earliest that new supply can be received is February 20.

Part A 702 is associated with level 1. Part A 702 would have one event (event 1 (710a)), which is a solid demand for due date=February 1, priority=medium, quantity=100. Parts B2 704a and B2 704b are associated with level 2. Part B1 704a would have one event (event 2 (710b)), which is also a solid demand for due date=February 10, priority=high. Parts C1 706a and C2 706b are associated with level 3. The total number of levels in event pool 708 is three.

As described earlier in connection with FIGS. 2 and 3, the present system begins processing level-by-level, beginning with level 1. Event 1 (710a) corresponding to part A 702 is a solid event at level 1 (step 310), so the system proceeds to process event 1 (710a) depth-first (step 312). With reference to FIG. 4, event 1 (710a) cannot be satisfied at level 1 (step 408) because there is no existing supply to satisfy the demand. Therefore, the present system proceeds to perform a trial on each available path (step 414). Multiple paths are available to satisfy the demand (e.g., trial 1 using part B1 704a, and trial 2 using part B2 704b).

With reference to FIG. 5, the present system performs a trial on trial 1 (involving part B1 704a). Trial 1 creates a new trial supply on part A 702. Trial 1 has dependent requirements for part B1 704a (step 502), therefore the present system generates a dependent dynamic event for part B1 704a (step 504), creating event 3 (710c). Event 3 (710c) is created in level 2. In some embodiments, the present system can revise relevant attributes to account for shipping, transportation, or transfer time. For simplicity, the present discussion assumes that transfer time is instantaneous. Therefore, because due date=February 1 and priority=medium for part A 702, event 3 (710c) similarly has attributes due date=February 1 and priority=medium for part B1 704a. If transfer time were not instantaneous, attributes for subparts or components would need corresponding earlier availability dates.

The present system proceeds to process event 3 (710c) depth first (step 312). Event 3 (710c) is a dependent dynamic event, therefore the present system proceeds to determine whether there is a more important solid event at level 2 (step 404). Event 2 (710b) is a more important solid event at level 2, because event 2 (710b) has priority=high. This processing illustrates hybrid balancing of supply and demand. Rather than proceed depth-first to process part C1 706a as part of dependent dynamic event 3 (710c), the present system processes event 2 (710b) associated with part B1 704a.

The present system proceeds to process event 2 (710b) depth first (step 312). Event 2 (710b) is associated with part B1 704a. There is no existing supply to satisfy demand for part B1 704a (step 408). The present system proceeds to perform a trial including the single path through part C1 706a (step 414). The present system creates trial 3 which creates new supply on part B1 704a. With reference to FIG. 5, the present system proceeds to determine whether there are dependent requirements for trial 3 including the new supply on part B1 704a (step 502).

The present system generates a dependent dynamic event for part C1 706a (step 504), event 4 (710d) associated with part C1 706a. Event 4 (710d) is in level 3. In some embodiments, the present system can account for assembly time. For simplicity, the present discussion assumes part B1 704a can be assembled instantaneously, meaning that event 4 (710d) associated with part C1 706a has due date=February 1 and priority=high. Because no further dependent dynamic events need to be generated (step 504), the present system proceeds to process dependent dynamic event 4 (710d) depth first (step 312).

With reference to FIG. 4, event 4 (710d) is a dependent dynamic event (step 402), so the present system proceeds to determine whether there is a more important solid event at level 3 (step 404). Because there is no more important solid event at level 3 (step 404: No), the present system proceeds to determine whether event 4 (710d) can be satisfied by existing supply of part C1 706a (step 408). Because available inventory=100 for part C1 706a, event 4 (710d) can be satisfied (step 418). Therefore, the calculated availability for event 4 (710d) is today (also referred to herein as January 15, assuming this example is performed on January 15) (step 420), because there is inventory available. Accordingly, the calculated availability for trial 3 new supply is January 15 (step 420). Because event 2 (710b) (corresponding to part B1 704a) is satisfied by trial 3, the calculated availability for event 2 (710b) is January 15 (step 420).

Processing for event 2 (710b) associated with part B1 704a is complete, so the present system returns to process event 3 (710c) associated with part B1 704a. Event 3 (710c) is a dependent dynamic event (step 402) in level 2. There is no more important solid event in level 2 waiting to be processed (step 404, and event 2 has already been processed), so the present system determines whether event 3 (710c) can be satisfied on part B1 704a (step 408). There is no existing supply on part B1 704a available to satisfy event 3 (710c) at level 2 (step 408: No), so the present system continues to perform a trial on the single path for event 3 (710c) (step 414), creating trial 4 new supply on part B1 704a.

There is a dependent requirement for trial 4 new supply (step 502), part C1 706a. The present system generates a new dependent dynamic event (event 5 (710e), associated with part C1 706a). As illustrated in event pool 708, event 5 (710e) is associated with level 3. The present process proceeds to process event 5 (710e) in level 3 depth-first (step 312).

With reference to FIG. 4, event 5 (710e) is a dependent dynamic event (step 402). There is no more important solid event at level 3 (step 404: No). There is no existing supply to satisfy event 5 (710e) (associated with part C1) at level 3 (step 408), because event 4 (710d) has used up the available supply=100. Event 5 (710e) can be satisfied with a new order for part C1 706b. As described earlier, availability for a new order is February 20. Accordingly, trial 4 new supply is satisfied and available on February 20 (steps 418-420). Event 3 (710c) is therefore satisfied by trial 4 new supply, so availability for event 3 (710c) is February 20 (steps 418-420). Therefore, trial 1 using part B1 704a can be satisfied on February 20 (using a new order for part C1 706a which arrives on February 20). Therefore, the present system has finished processing trial 1 associated with part B1 704a (step 414).

Because there are multiple paths, the present system processes trial 2 associated with part B2 704b (step 414) in a similar manner as described earlier. In particular, there are no more solid events on levels 2 or 3. The present system will determine that trial 2 can be satisfied with inventory of part C2 706b, with availability January 15.

The present system proceeds to choose the best path (step 416) among trial 1 and trial 2. Trial 1 provides supply late (February 20), whereas trial 2 provides supply on time (January 15). Therefore, the present system determines that trial 2 represents the best path for event 1 (710a) associated with part A 702. With reference to FIG. 3, the depth-first processing of event 1 (710a) at level 1 has completed (step 312). There are no more solid events at level 1 (step 310), so the present system proceeds to level 2 (step 220). With reference to FIG. 2, the present system proceeds to process level 2 (step 222).

There are no more solid demands to process on level 2 (event 2 (710b) associated with part B1 704a was previously processed as part of processing event 1 (710a) associated with part A 702). The present system proceeds to process level 3 (step 222). Similarly, there are no more solid demands to process on level 3. The present system proceeds to store final results (step 224). The final results are that event 1 (710a) associated with part A 702 is associated with the path including part B2 704b which is satisfied by part C2 706b (arriving on time). Event 2 (710b) associated with part B 704a and with priority=high is satisfied by inventory from part C1 706a (also arriving on time).

Of course, although specific steps are disclosed in FIGS. 2-5, such steps are exemplary. That is, the present system is well-suited to performing various other steps or variations of the steps recited in FIGS. 2-5. The steps in FIGS. 2-5 may be performed in an order different than presented, and not all of the steps may be performed. FIGS. 2-5 include processes that, in various embodiments, are carried out by a processor under the control of computer-readable and computer-executable instructions. Embodiments of the present disclosure may thus be stored as non-transitory computer-readable media or computer-executable instructions including, but not limited to, firmware updates, software update packages, or hardware (e.g., ROM).

Reference has been made in detail to various embodiments in accordance with the present disclosure, examples of which are illustrated in the accompanying drawings. While the invention has been described in conjunction with various embodiments, these various embodiments are not intended to limit the invention. On the contrary, the invention is intended to cover alternatives, modifications, and equivalents, which may be included within the scope of the invention as construed according to the appended claims. Furthermore, in the detailed description of various embodiments, numerous specific details have been set forth in order to provide a thorough understanding of the invention. However, the invention may be practiced without these specific details. In other instances, well known methods, procedures, components, and circuits have not been described in detail, so as not to unnecessarily obscure aspects of the invention.

Some portions of the detailed descriptions have been presented in terms of procedures, logic blocks, processing, and other symbolic representations of operations on data bits within a non-transitory computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of operations or steps or instructions leading to a desired result. The operations or steps are those utilizing physical manipulations and transformations of physical quantities. Usually, although not necessarily, these quantities take the form of electrical or magnetic signals capable of being stored, transferred, combined, compared, and otherwise manipulated in a computer system or computing device.

Of course, all of these and similar terms are to be associated with the appropriate physical quantities and are merely convenient labels applied to these quantities. Unless specifically stated otherwise as apparent from the foregoing discussions, it is appreciated that throughout the present disclosure, discussions utilizing terms such as “enabling,” “sending,” “receiving,” “determining,” “responding,” “generating,” “making,” “accessing,” “associating,” “allowing,” “updating,” or the like, refer to actions and processes of a computer system or similar electronic computing device or processor. The computer system or similar electronic computing device manipulates and transforms data represented as physical (electronic) quantities within the system memories, registers or other such information storage, transmission or display devices.

The present systems and methods can be implemented in a variety of architectures and configurations. For example, the present systems and methods can be implemented as part of a distributed computing environment, a cloud computing environment, a client server environment, etc. The embodiments described herein may be discussed in the general context of computer-executable instructions residing on some form of non-transitory computer-readable storage medium, such as program modules, executed by one or more computers, computing devices, or other devices. As described earlier, non-limiting examples of computer-readable storage media may include storage media and communication media. Generally, program modules include routines, programs, objects, components, data structures, etc., that perform particular tasks or implement particular abstract data types. The functionality of the program modules may be combined or distributed as desired in various embodiments.

The foregoing descriptions of specific embodiments of the present systems and methods have been presented for purposes of illustration and description. The specific embodiments are not intended to be exhaustive or to limit the invention to the precise forms disclosed, and many modifications and variations are possible in light of the above description. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer-implemented method for fulfilling supply and demand, the method comprising:
receiving a demand for a resource;
determining a plurality of relationships among related resources, the related resources representing dependent resources needing to be fulfilled in order to fulfill the demand for the resource, and the relationships grouping the related resources into levels according to the dependencies; and
for each level,
processing dependent resources depth-first proceeding down levels, if an importance of the related resources indicates there are no more important related resources to process at the level, and
interrupting the depth-first processing to process related resources breadth-first at the level, if the importance of the related resources indicates there are more important related resources at the level.

2. The method of claim 1, wherein the resources represent at least one of elements for allocation, objects for allocation, individuals for allocation, parts for order fulfillment, and components for order fulfillment.

3. The method of claim 1, further comprising
for each level,
managing a resource pool by first processing the related resources without attributes needing dynamic simulation, prior to processing the related resources with attributes needing dynamic simulation.

4. The method of claim 1, wherein the processing the dependent resources depth-first includes processing the dependent resources in a sequence, based at least in part on at least one of a projected availability date, a due date, an importance, a priority, and a required quantity for each resource.

5. The method of claim 3, wherein the dynamic simulation includes modifying at least one of a projected availability date, a due date, an importance, a priority, and a required quantity for the related resource, based at least in part on at least one of the projected availability date, the due date, the importance, the priority, and the required quantity of the dependent resources.

6. The method of claim 3, wherein the dynamic simulation includes determining an availability of a potential path, reserving dependent resources for the potential path, and releasing the dependent resources if an alternate path is found which better meets the demand for the resource.

7. The method of claim 4, wherein the processing the dependent resources and the processing the related resources includes determining whether at least one of the availability date, the due date, the importance and the priority can be satisfied at the level, based at least in part on the required quantity.

8. A system for fulfilling supply and demand, the system comprising:
memory;
storage; and
at least one processor configured to use the memory and storage to:
receive a demand for a resource;
determine a plurality of relationships among related resources, the related resources representing dependent resources needing to be fulfilled in order to fulfill the demand for the resource, and the relationships grouping the related resources into levels according to the dependencies; and
for each level,
process dependent resources depth-first proceeding down levels, if an importance of the related resources indicates there are no more important related resources to process at the level, and
interrupt the depth-first processing to process related resources breadth-first at the level, if the importance of the related resources indicates there are more important related resources at the level.

9. The system of claim 8, wherein the resources represent at least one of elements for allocation, objects for allocation, individuals for allocation, parts for order fulfillment, and components for order fulfillment.

10. The system of claim 8, further comprising:
the at least one processor configured to
for each level,
manage a resource pool by first processing the related resources without attributes needing dynamic simulation, prior to processing the related resources with attributes needing dynamic simulation.

11. The system of claim 8, wherein the at least one processor configured to process the dependent resources depth-first further comprises the at least one processor further configured to process the dependent resources in a sequence, based at least in part on at least one of a projected availability date, a due date, an importance, a priority, and a required quantity for each resource.

12. The system of claim 10, wherein the dynamic simulation further comprises the at least one processor configured to modify at least one of a projected availability date, a due date, an importance, a priority, and a required quantity for the related resource, based at least in part on at least one of the projected availability date, the due date, the importance, the priority, and the required quantity of the dependent resources.

13. The system of claim 10, wherein the dynamic simulation further comprises the at least one processor configured to determine an availability of a potential path, reserve dependent resources for the potential path, and release the dependent resources if an alternate path is found which better meets the demand for the resource.

14. The system of claim 11, wherein the at least one processor configured to process the dependent resources and configured to process the related resources further comprises the at least one processor configured to determine whether at least one of the availability date, the due date, the importance and the priority can be satisfied at the level, based at least in part on the required quantity.

15. A non-transitory computer program product for fulfilling supply and demand, the non-transitory computer program product tangibly embodied in a computer-readable medium, the non-transitory computer program product including instructions operable to cause a data processing apparatus to:
receive a demand for a resource;
determine a plurality of relationships among related resources, the related resources representing dependent resources needing to be fulfilled in order to fulfill the demand for the resource, and the relationships grouping the related resources into levels according to the dependencies; and
for each level,
process dependent resources depth-first proceeding down levels, if an importance of the related resources indicates there are no more important related resources to process at the level, and
interrupt the depth-first processing to process related resources breadth-first at the level, if the importance of the related resources indicates there are more important related resources at the level.

16. The non-transitory computer program product of claim 15, further comprising:
instructions operable to cause the data processing apparatus to
for each level,
manage a resource pool by first processing the related resources without attributes needing dynamic simulation, prior to processing the related resources with attributes needing dynamic simulation.

17. The non-transitory computer program product of claim 15, further comprising
instructions operable to cause the data processing apparatus to
for each level,
manage a resource pool by first processing the related resources without attributes needing dynamic simulation, prior to processing the related resources with attributes needing dynamic simulation.

18. The non-transitory computer program product of claim 15, wherein the instructions operable to cause the data processing apparatus to process the dependent resources depth-first further comprise instructions operable to cause the data processing apparatus to process the dependent resources in a sequence, based at least in part on at least one of a projected availability date, a due date, an importance, a priority, and a required quantity for each resource.

19. The non-transitory computer program product of claim 17, wherein the dynamic simulation further comprises instructions operable to cause the data processing apparatus to modify at least one of a projected availability date, a due date, an importance, a priority, and a required quantity for the related resource, based at least in part on at least one of the projected availability date, the due date, the importance, the priority, and the required quantity of the dependent resources.

20. The non-transitory computer program product of claim 18, wherein the instructions operable to cause the data processing apparatus to process the dependent resources and to process the related resources further comprises the at least one processor configured to determine whether at least one of the availability date, the due date, the importance and the priority can be satisfied at the level, based at least in part on the required quantity.
